(19) United States
(12) Patent Application Publication
(10) Pub. No.: US 2016/0261923 A1
(43) Pub. Date: Sep. 8, 2016

(54) ASPECT RATIO ADJUSTMENT METHOD AND APPARATUS OF SMART TELEVISION

(71) Applicant: LE SHI ZHI XIN ELECTRONIC TECHNOLOGY (TIANJIN) LIMITED, Beijing (CN)

(72) Inventors: Peng HUANG, Beijing (CN); Jiazi TIAN, Beijing (CN); Yonghui TONG, Beijing (CN)

(73) Assignee: LE SHI ZHI XIN ELECTRONIC TECHNOLOGY (TIANJIN) LIMITED, Beijing (CN)

(21) Appl. No.: 15/033,601

(22) PCT Filed: Oct. 29, 2014
(86) PCT No.: PCT/CN2014/089838

§ 371 Date: Apr. 29, 2016

(30) Foreign Application Priority Data
Oct. 30, 2013 (CN) 201310530872.4

(51) Int. Cl. H04N 21/61; H04N 21/234; H04N 21/2343; G06T 3/40; G06T 7/60; H04N 5/262; G06T 7/00

(52) U.S. Cl. CPC H04N 21/6125; H04N 5/2628; H04N 21/23418; G06T 7/0085; G06T 3/40; G06T 7/60; H04N 21/2343

(57) ABSTRACT

Disclosed are an aspect ratio adjustment method and an apparatus of a smart television, wherein the aspect ratio adjustment method comprises: identifying an aspect ratio of an input video source and a screen size of a display device; based on the aspect ratio of the video source, adjusting a picture of the video source proportionally, making a picture width of the video source be equal to a screen width of the display device; based on the aspect ratio of the video source and the screen width of the display device, obtaining a picture height of the video source after adjustment; and based on a screen height of the display device and the picture height of the video source after the adjustment, longitudinally adjusting the picture of the video source after the adjustment. The aspect ratio adjustment method and the apparatus of the smart television provided by the present application can automatically remove a horizontal black border of a play interface of a video in a screen, making an aspect ratio more suitable for watching. While a good watching effect is obtained, a user is exempted from a trouble of manual adjustment at the same time, simplifying a user operation.

### CROSS-REFERENCE

This application claims the benefit of Chinese Patent Application 201310530872.4, titled “Aspect Ratio Adjustment Method and Apparatus of Smart Televisions”, filed on Oct. 30, 2013, the entire contents of which are incorporated herein by reference.

### TECHNICAL FIELD

The present application relates to the field of smart televisions, and more particularly, to a method and a device for adjusting aspect ratio of smart televisions.

### BACKGROUND

With improvement of people's living standard, smart TVs are becoming more popular in the household. The trend of replacing the traditional TVs becomes more and more strong. The smart TVs play a more and more important role in people's daily leisure and entertainment life.

At present, the aspect ratio of different TV program videos in a TV display screen is not unified. Most of high-definition digital TV program videos are broadcasted in the aspect ratio of 16:9. However, most of ordinary TV program videos are broadcasted in the aspect ratio of 4:3. In the meantime, the situations that some TV program videos are broadcasted in a special aspect ratio also exist. In addition, the aspect ratio of network videos manufactured by different manufacturers in the TV display screen is not unified in the network due to the non-uniform manufacturing standard either. However, due to different living standards in different regions of our country, the TVs in the households may be actually purchased in different eras, including traditional CRT (Cathode Ray Tube) TVs, liquid crystal/plasma display panel TVs and the latest super-high definition TVs and other multiple types. These different types of TVs are provided with display screens with different width-to-height ratios (i.e., different ratios of display screen). For instance, the current display screens are in various ratios, such as 4:3, 16:9, 16:10, and so on. However, when different TV program videos and network videos are broadcasted in different types of televisions, a problem that the aspect ratio of the video in the TV display screen is not matched with the screen ratio is extremely prone to occur. Moreover, such mismatch may also result in black edges in the broadcast interface, where the black edges specifically present around the video image, or the black edges present at the upper border and the lower border of the video image, or the black edges present at the left border and the right border of the video image. FIG. 1 is a schematic diagram of a image in the prior art, wherein I represents a screen, A is the width of the display screen, B is the height of the display screen, A/B is a screen ratio (a width-to-height of the display screen), II represents a image of a video, C is the transverse width of the video, D is the longitudinal height of the video, C/D is the aspect ratio (the width-to-height of the image) of the video, III represents there are black edges in the broadcast interface when the aspect ratio of the video in the TV display screen is not matched with the screen ratio (the value of the C/D is not equal to the value of the A/B). The existence of these black edges would certainly affect the watch effect on the video image for a user.

In the TV products of the prior art, some common aspect ratios may generally be preset as options, such as the aspect ratio of 4:3 or 16:9 for the user to select manually, so as to adjust the aspect ratio of the video in the TV display screen, and avoid the black edges in the broadcast interface.

However, all aspect ratios corresponding to various videos are unable to be preset in the existing televisions. More particularly, the black edges may also appear during the broadcast of some special videos. What's more important is that according to the existing method for manually selecting the aspect ratio by the user, the other subsequently-watched TV program videos or other network videos are still broadcasted in a fixed aspect ratio after the user selects the aspect ratio for the current video. When the aspect ratio of the other subsequently-watched TV program videos or other network videos in the TV display screen is not matched with the screen ratio, the black edges appear as well. At this moment, the user may only manually select the an appropriate aspect ratio again, and such frequent manual selection mode will undoubtedly complicates the operation process for the user, which results in a heavy workload and a trouble of poor experience of the user.

### SUMMARY

The embodiment of the present application provides a method and a device for adjusting aspect ratio of smart televisions, so as to solve the problem that manual adjustment on the aspect ratio is required to remove a black edge when watching a TV program.

In order to achieve the foregoing object, the embodiments of the present application employ the following technical solutions.

According to a first aspect, a method for adjusting aspect ratio of smart TV, includes: identifying an aspect ratio of an inputted video source and a screen size of a display device; adjusting the image of the video source proportionally according to the aspect ratio of the video source such that the image width of the video source is equal to a screen width of the display device; and acquiring a image height of the video source after adjustment according to the aspect ratio of the video source and the screen width of the display device, and longitudinally adjusting the image of the video source after adjustment according to a screen height of the display device and the image height of the video source after adjustment.

According to a second aspect, a method for adjusting aspect ratio of smart televisions, includes: identifying an aspect ratio of an inputted video source and a screen size of a display device; adjusting an image of the video source proportionally according to the aspect ratio of the video source such that an image height of the video source is equal to the screen height of the display device; and acquiring an image width of the video source after adjustment according to the aspect ratio of the video source and the screen height of the display device, and transversely adjusting the image of the video source after adjustment according to a screen width of the display device and the image width of the video source after adjustment.

According to a third aspect, there is provided an apparatus for adjusting aspect ratio of smart televisions, includes: an identification module, configured to identify an aspect ratio of an inputted video source and a screen size of a display device; a pre-adjustment module, coupled with the identification module and configured to adjust an image of the video source proportionally according to the aspect ratio of the video source such that an image width of the video source is equal to a screen width of the display device; an acquisition module, coupled with the identification module and configured to acquire an image height of the video source after adjustment according to the aspect ratio of the video source and the screen width of the display device; and an adjustment module, coupled with the identification module, the acquisition module and the pre-adjustment module respectively, and configured to longitudinally adjust the image of the video source after adjustment according to a screen height of the display device and the image height of the video source after adjustment.

According to a fourth aspect, an apparatus for adjusting aspect ratio of smart televisions, includes: an identification module, configured to identify an aspect ratio of an inputted video source and a screen size of a display device; a pre-adjustment module, coupled with the identification module and configured to adjust an image of the video source proportionally according to the aspect ratio of the video source such that an image height of the video source is equal to a screen height of the display device; an acquisition module, coupled with the identification module and configured to acquire an image width of the video source after adjustment according to the aspect ratio of the video source and the screen height of the display device; and an adjustment module, coupled with the identification module, the acquisition module and the pre-adjustment module respectively, and configured to transversely adjust the image of the video source after adjustment according to a screen width of the display device and the image width of the video source after adjustment.

### BRIEF DESCRIPTION OF THE DRAWINGS

FIG. 1 is a schematic diagram of the image in the prior art.

FIG. 2 is a schematic diagram of the image according to embodiments of the present application.

FIG. 3 is a flow chart of a method according to a first embodiment of the present application.

FIG. 4 is a flow chart of a method according to a second embodiment of the present application.

FIG. 4a, FIG. 4b and FIG. 4c are schematic diagrams of the image according to embodiments of the present application.

FIG. 5 is a flow chart of a method according to a third embodiment of the present application.

FIG. 6 is a flow chart of a method according to a fourth embodiment of the present application.

FIG. 7a and FIG. 7b are schematic diagrams of the image according to embodiments of the present application.

FIG. 8 is a flow chart of a method according to a fifth embodiment of the present application.

FIG. 9 is a flow chart of a method according to a sixth embodiment of the present application.

FIG. 10a and FIG. 10b are schematic diagrams of the image according to embodiments of the present application.

FIG. 11 is a flow chart of a method according to a seventh embodiment of the present application.

FIG. 12 is a flow chart of a method according to an eighth embodiment of the present application.

FIG. 13 is a flow chart of a method according to a ninth embodiment of the present application.

FIG. 14 is a flow chart of a method according to a tenth embodiment of the present application.

FIG. 15 is a flow chart of a method according to an eleventh embodiment of the present application.

FIG. 16 is a flow chart of a device according to a twelfth embodiment of the present application.

FIG. 17 is a flow chart of a device according to a thirteenth embodiment of the present application.

### PREFERRED EMBODIMENTS

The embodiments of the present application will be explained in details with reference to the drawings and embodiments hereinafter, so that the realization process of how to solve the technical problems using a technical means and achieve the technical effect can be fully understood and implemented accordingly.

### First Embodiment

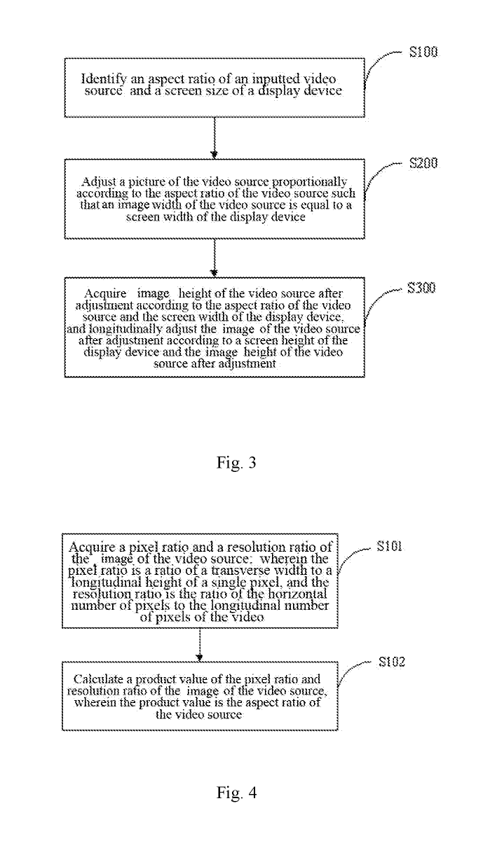

FIG. 3 is a flow chart of a method according to embodiments of the present application.

FIG. 3 shows a method for adjusting aspect ratio of smart TV provided by the embodiment of the present application, including the following steps.

In step S100, an aspect ratio of an input video source and a screen size of a display device are identified.

The aspect ratio of the video source here generally refers to the width-to-height ratio of the image. Certainly, the aspect ratio described in the present application is not limited to the width-to-height ratio of the image, and other parameters capable of uniquely determining the aspect ratio relation may also be the aspect ratio described in the present application.

The width-to-height ratio of the image refers to the ratio of the transverse width and the longitudinal height of the original video image. Moreover, the screen of the display device also has a width-to-height ratio of the display screen. The width-to-height ratio of the display screen refers to the ratio of the transverse width to the longitudinal height of the screen. In the actual experience, the width-to-height ratio of the image does not always adapt to the width-to-height ratio of display screen. Therefore, black edges mainly appear at the left side and the right side of the screen, between the image of the video source and the screen, when broadcasting in the screen of the display device. The black edges at the left side and the right side drags a user from a watching motion and scene that was just cultivated, which extremely affect the user experience.

The screen size of the display device generally refers to a screen height and a screen width. Of course, the screen size described in the present application is not limited herein. Other parameters capable of uniquely determining the screen size, such as a screen diagonal length, are also part of the screen size described in the present application.

In step S200, the image of the video source is adjusted proportionally according to the aspect ratio of the video source such that an image width of the video source is equal to a screen width of the display device.

The image of the video source is adjusted proportionally such that the image width is equal to the screen width of the display device. In this way, there are three situations for the adjusted image as follows:

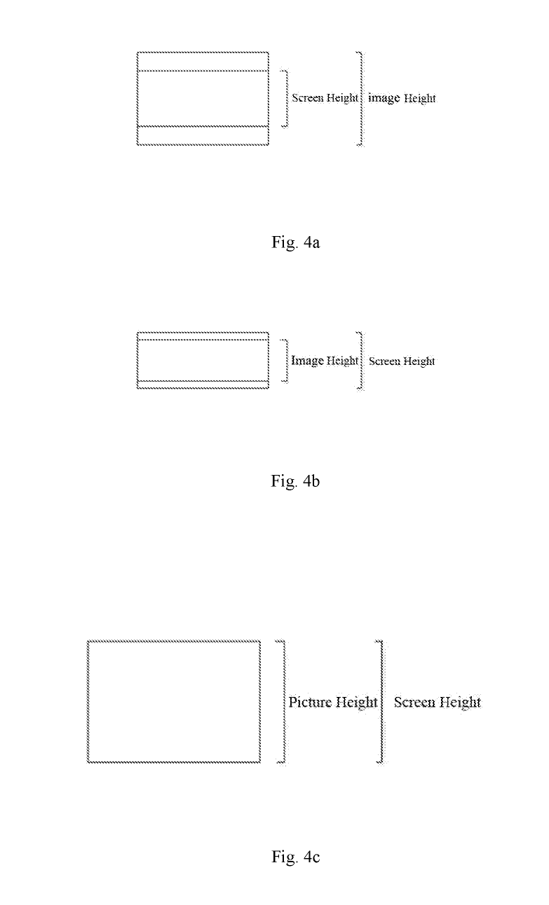

1) when the image height is greater than the screen height, as shown in FIG. 4a, this explains that the aspect ratio (width-to-height ratio) of the video source is less than the screen ratio (width-to-height ratio). The image of the video source is lanky with respect to the screen. The image of the video source after adjustment longitudinally exceeds above and below the screen of the display device;

2) when the image height is less than the screen height, as shown in FIG. 4b, this explains that the aspect ratio (width-to-height ratio) of the video source is greater than the screen ratio (width-to-height ratio). The image of the video source is flat with respect to the screen. The image of the video source after adjustment is unable to longitudinally fill in the screen of the display device, leaving borders at the upper and lower aspect of the screen; and

3) when the image height is equal to the screen height, as shown in FIG. 4c, this explains that the aspect ratio (width-to-height ratio) of the video source is equal to the screen ratio (width-to-height ratio). The image of the video source after adjustment also longitudinally fills in the screen of the display device just in time.

In step S300, a image height of the video source after adjustment is acquired according to the aspect ratio of the video source and the screen width of the display device. The image of the video source after adjustment is longitudinally adjusted according to a screen height of the display device and the image height of the video source after adjustment.

The image width of the video source after adjustment is equal to the screen width of the display device. Therefore, the adjustment may be finished according to the image ratio of the video source and the screen width of the display device, that is according to the image width of the video source after adjustment and the aspect ratio of the video source. Although the screen width of the display device and the aspect ratio has been acquired in step S100, it needs to wait the adjustment result of the step S200 before the step S300 is performed. This is because that the adjustment in the step S200 is to scale the image proportionally. The adjustment in the step S300 needs to compress and stretch the image, which downgrades the image quality.

It should be noted that the image may be longitudinally overspread the whole screen through processing after the longitudinal adjustment, or the black edges above and below the image are filled in through processing, in which way the image does not overspread the whole screen. To be specific, through the step S200, the embodiment of the present application may make the video to transversely fill in the screen to remove the black edges at the left and right sides of the screen. However, three situations in the step S200 may occur in the longitudinal direction. For the situation of the image overflowing the screen in the first situation, the whole image needs to be compressed, or particularly, the overflowed portion needs to be compressed. Of course, the overflowed portion may also be cut. In this case, the image will longitudinally overspread the whole screen, referring to the third embodiment. For the situation of the image incapable of longitudinally filling in the screen in the second situation, the place incapable of being filled may be filled. In this case, the image does not longitudinally overspread the whole screen. Of course, the whole image may also be stretched or the image edge portion may be stretched. In this case, the image will longitudinally overspread the whole screen, referring to the fifth embodiment. For the third situation, the aspect ratio is suitable for the screen ratio. The screen will be longitudinally filled while the screen is transversely filled to achieve the best effect of maintaining the aspect ratio and broadcasting in full screen. The re-adjustment does not need to be performed at this moment.

When applying the technical solutions provided by the embodiments of the present application, the aspect ratio may be more suitable for watching no matter which aspect ratio is provided in the currently-accessed video. While a preferable watch effect is obtained, a user is exempted from a trouble of manual adjustment at the same time, which simplifies a user operation and improves user experiences.

The first embodiment is explained preferably by an application example hereinafter.

In the prior art, when black edges appear between the image of the current video and the screen interface, the broadcast interface ratio is manually selected by a user from the options provided by the TV as a rule. The other subsequently-watched TV program videos or other network videos are still broadcasted in a fixed broadcast interface ratio after the user selects the broadcast interface ratio for the current video. When the aspect ratio of other subsequently-watched TV program videos or other network videos is not matched with the broadcast interface ratio, the black edges will appear as well. At this moment, the user may only manually select an appropriate broadcast interface ratio once again.

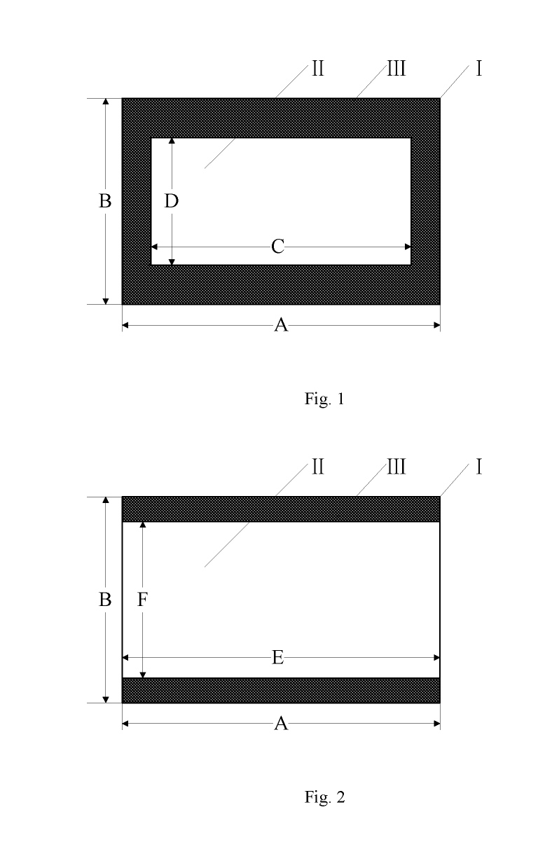

In the embodiment of the present application, FIG. 2 shows a schematic diagram of a image according to the embodiment of the present application. I represents a screen, A is a screen width, B is a screen height, AB is a screen ratio (width-to-height ratio of display screen), II represents a image of a video source, E is a width of a video transversely filling in the screen, F is a longitudinal height of the video transversely filling in the screen, E/F is an aspect ratio of the video after adjustment (the width-to-height ratio of the adjusted image) and III represents the situation that the left black edge and the right black edge are removed after the aspect ratio of the image in the TV display screen is adjusted. It is thus clear that, in the application example, the aspect ratio will be acquired when accessing the image of one video source every time, and the current video transversely fills in the screen by adjusting in combination with the screen size. In this way, the black edges at the left and the right of the display screen in the transverse direction may be removed, so that the transverse width direction watched by the user is not affected by the left black edge and the right black edge. Accordingly, the wider video display area is more adaptable to the visual watching effect.

### Second Embodiment

FIG. 4 is a flow chart of a method according to a second embodiment of the present application.

FIG. 4 shows the method, including the following steps.

In step S101, the pixel ratio and the resolution ratio of the image of the video source are acquired. The pixel ratio is a ratio of a transverse width to a longitudinal height of a single pixel, and the resolution ratio is the ratio of the horizontal number of pixels to the longitudinal number of pixels of the video.

In step S102, a product value of the pixel ratio and resolution ratio of the image of the video source is calculated, and the product value is the aspect ratio of the video source.

Generally, the pixel ratio is the ratio of the transverse width to the longitudinal height of the single pixel. And the resolution ratio is the ratio of the horizontal number of pixels to the longitudinal number of pixels of the video. The product of the pixel ratio and resolution ratio of the video is the aspect ratio of the video (for instance, width-to-height ratio of image).

For instance, for most videos in the RMVB format, the pixel ratio is 1:1. If the resolution ratio is 640:360, this means the whole video image is divided into 640×360 blocks, each block of which is a square pixel of one video. The aspect ratio of the video is 640:360, that is, 16:9 at this moment.

For instance, for most videos in the VCD, MPG or DAT format, the pixel ratio is 12:11. If the resolution ratio is 352×288, this means the whole video image is divided into 352×288 blocks, each block of which is a rectangle pixel of one video with the length-to-width ratio of 12:11. The aspect ratio of the video is (352×12): (288×11)=4224:3168, that is, 4:3 at this moment.

It is understandable that when acquiring the resolution ratio and the pixel ratio of the video file, the product of the pixel ratio and resolution ratio is the width-to-height ratio of image of the video. And in the situation that the pixel ratio is 1:1, the aspect ratio of the video is equal to the resolution ratio of the video.

### Third Embodiment

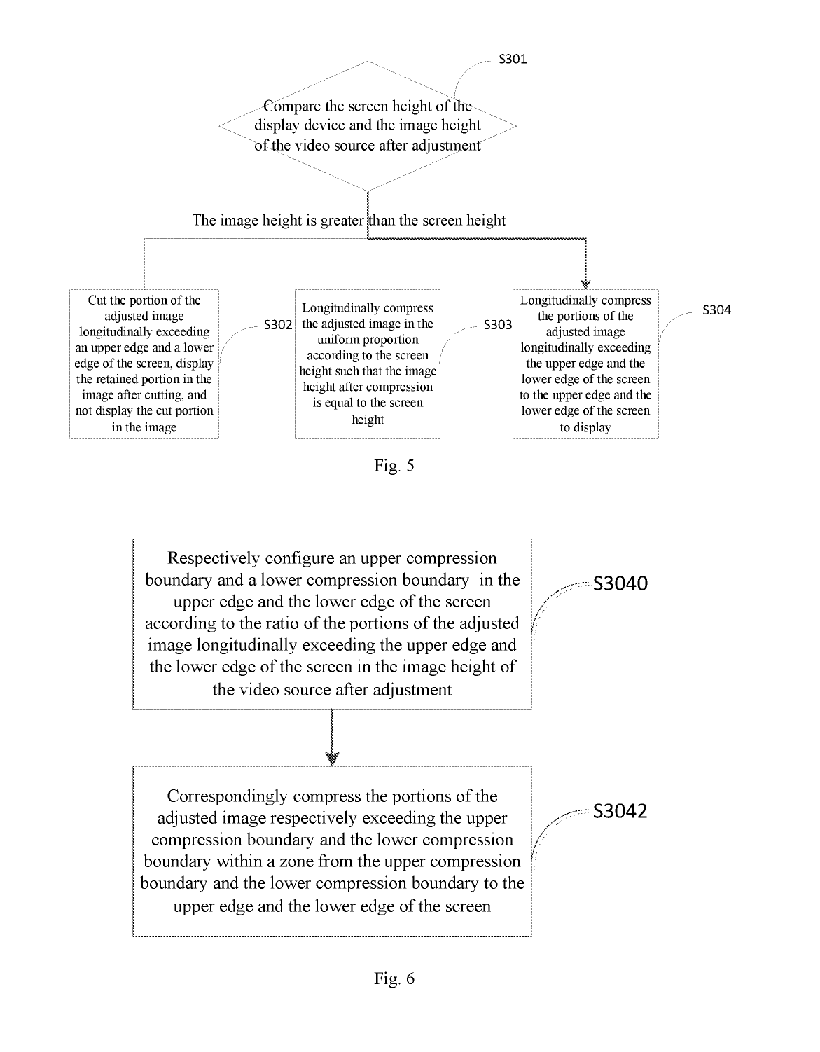

FIG. 5 is a flow chart of a method according to a third embodiment of the present application. It is an adjustment method for the image of the video source after adjustment longitudinally overflowing above and below the screen of the display device in the situation that the image width of the video source is equal to the screen width of the display device after the image of the video source is adjusted in the equal proportion.

FIG. 5 shows the method, including the following steps.

In step S301, the screen height of the display device and the image height of the video source after adjustment are compared. When the image height is greater than the screen height, step S302 or step S303 or step S304 is performed.

In step S302, the portion of the adjusted image longitudinally exceeding an upper edge and a lower edge of the screen is cut, the retained portion in the image after cutting is displayed, but the cut portion in the image is not displayed.

The image with the original aspect ratio is completely retained for the displayed image in such cutting mode. However, the user will omit the images filled in the image during the course of watching if the cut portion is not displayed, which causes the incomplete feeling during the course of watching. If the image information is focused in the middle position, such mode is still preferable.

In step S303, the adjusted image is longitudinally compressed in the uniform proportion according to the screen height such that the image height after compression is equal to the screen height.

The image is deformed greatly as a whole through such compression mode. Only because of a uniform proportion, the visual image caused by the deformation is weakened.

In step S304, the portions of the adjusted image longitudinally exceeding the upper edge and the lower edge of the screen are longitudinally compressed to the upper edge and the lower edge of the screen to display.

Most of the positions in the middle of the image are retained in accordance with the original aspect ratio in such compression mode, which may ensure the image quality well. Certainly, to adapt to the ratio of the screen, the compressed portion is located at the edge of the image. The image quality of the whole image is not greatly affected by the deformation of the edge position. The quality feeling of original image is retained to the greatest extend in such mode.

### Fourth Embodiment

FIG. 6 is a flow chart of a method according to a fourth embodiment of the present application. The edge compression mode of the step S304 in the third embodiment is specifically explained.

FIG. 6 shows the method, including the following steps.

In step S3040, an upper compression boundary and a lower compression boundary are respectively configured in the upper edge and the lower edge of the screen according to the ratio of the portions of the adjusted image longitudinally exceeding the upper edge and the lower edge of the screen in the image height of the video source after adjustment.

The greater the ratio is, the larger the area needs to be compressed. The compressed image in this portion is too compact if the portion assigned for the compressed image is relatively small. The compressed image and the image with normal aspect ratio are spliced, which makes the whole image very asymmetric. Therefore, the greater the ratio is, the more partial the upper compression boundary and lower compression boundary is to the center of the screen. That is, more space is required for the compressed image, and the area of the image to be compressed is also increased correspondingly. However, the upper compression boundary and the lower compression boundary are also not partial to the center of the screen without limit. The image in the center of the screen is most important, which needs to ensure the portion of the center of the screen is displayed with the original aspect ratio.

In step S3042, the portions of the adjusted image respectively exceeding the upper compression boundary and the lower compression boundary are correspondingly compressed within a zone from the upper compression boundary and the lower compression boundary to the upper edge and the lower edge of the screen to display.

The image compression ratio from the upper compression boundary and the lower compression boundary to the upper edge and the lower edge of the screen is correspondingly increased during compression, so as to ensure the smooth transition of the image of the video source along a direction from the center of the screen to the edge of the screen in the upper compression boundary and the lower compression boundary. In this way, for the portion of the compressed image between the upper compression boundary and the lower compression boundary, the image is not deformed. The closer the portion of the compressed image outside the upper compression boundary and lower compression boundary is to the edge of the screen, the higher the deformation degree of the image is.

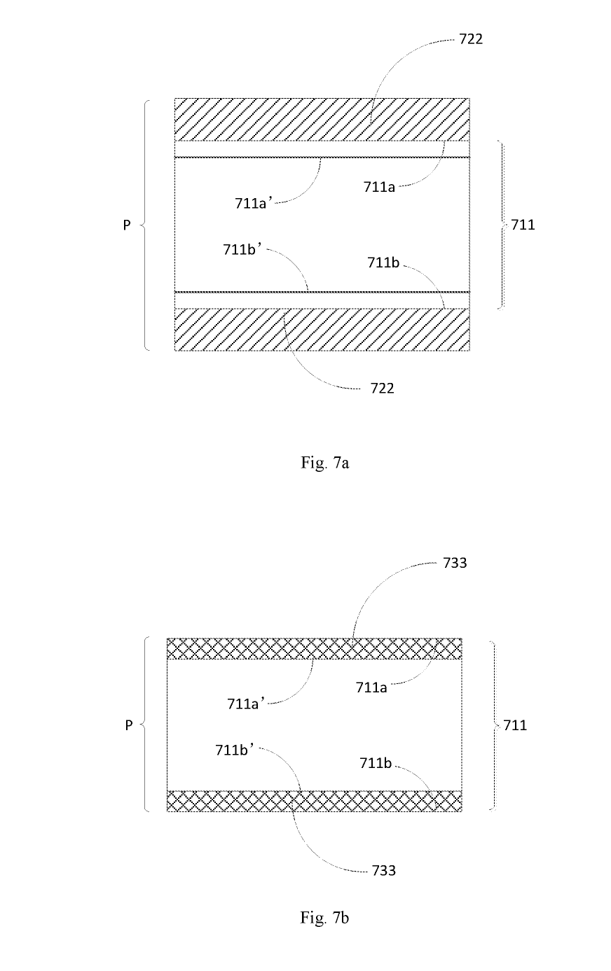

For instance, as shown in FIG. 7a, a blank block in the figure is a screen 711. An upper edge and a lower edge of the screen 711 are 711a and 711b respectively. A shaded portion 722 is a portion of image P of the video source overflowing the screen. The upper edge and the lower edge of the screen 711 are configured with an upper compression boundary 711a′ and a lower compression boundary 711b′ respectively. The image between the 711a′ and the 711a and the image of the shaded portion 722 at this side are compressed together to be displayed between the 711a′ and the 711a. The image between the 711b′ and the 711b and the image of the shaded portion 722 at this side are compressed together to be displayed between the 711b′ and the 711b. It is as shown in FIG. 7b after compression. A shaded portion 733 in the figure is a portion compressed in the screen 711. For the portion between the upper compression boundary 711a′ and the lower compression boundary 711b′, the image is not deformed. For the portion outside the upper compression boundary 711a′ and the lower compression boundary 711b′, the closer the portion is to the upper edge 711a and the lower edge 711b, the higher the deformation degree of the image is. The image compression ratio from the upper compression boundary 711a′ to the upper edge 711a of the screen is correspondingly increased. And the image compression ratio from the lower compression boundary 711b′ to the lower edge 711b of the screen is correspondingly increased. In this way, the smooth transition of the image of the vide source along a direction from the center of the screen to the edge of the screen in the upper compression boundary 711a′ and the lower compression boundary 711b′. The image is not changed abruptly.

Most of the positions in the middle of the image are retained in accordance with the original aspect ratio by applying the technical solution above, which may ensure the image quality well. Certainly, to adapt to the ratio of the screen, the compressed portion is located at the edge of the image. The image quality of the whole image is not greatly affected by the deformation of the edge position. The quality feeling of original image is retained at the greatest extend in such mode.

### Fifth Embodiment

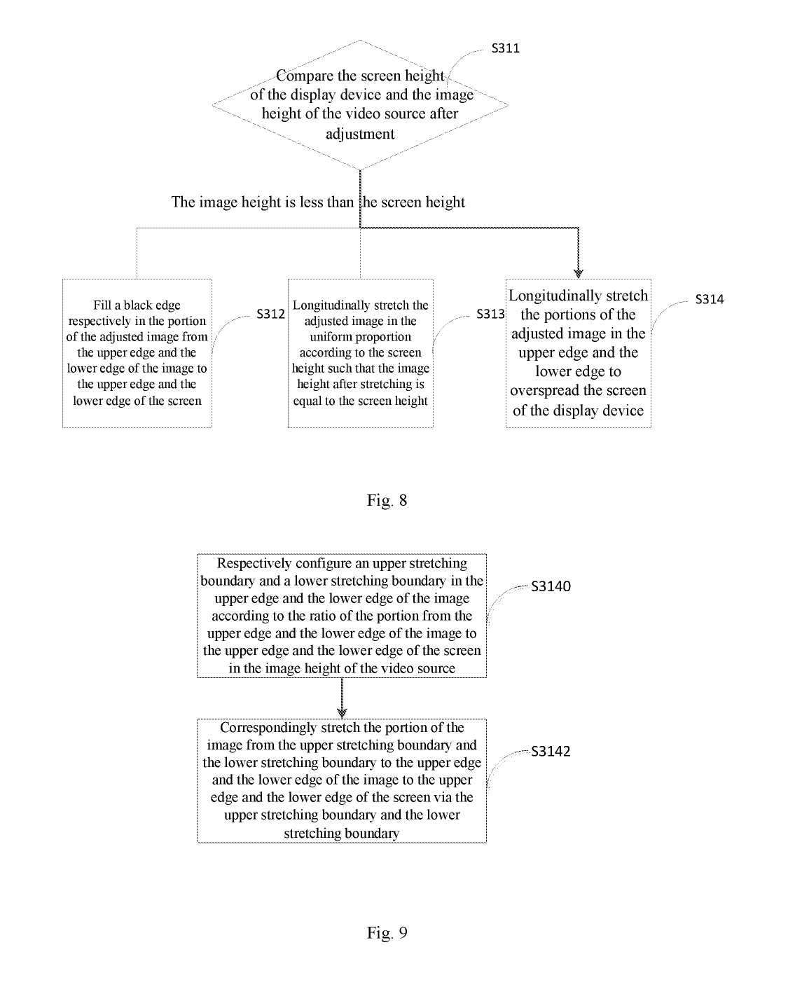

FIG. 8 is a flow chart of a method according to a fifth embodiment of the present application. It is aiming at the situation that the image of the video source after adjustment is unable to longitudinally fill in the screen when the image width of the video source is equal to the screen width of the display device and after the image of the video source is adjusted in the equal proportion.

FIG. 8 shows the method, including the following steps.

In step S311, the screen height of the display device and the image height of the video source after adjustment are compared. When the image height is less than the screen height, step S312 or step S313 or step S314 is performed.

In step S312, a black edge is respectively filled in the portion of the adjusted image from the upper edge and the lower edge of the image to the upper edge and the lower edge of the screen.

The image with the original aspect ratio is completely retained for the displayed image in a mode of filling the black edges. However, the filled black edges still affects the user's watching, which drags the user from a watching motion to affect the watching experience.

In step S313, the adjusted image is longitudinally stretched in the uniform proportion according to the screen height such that the image height after stretching is equal to the screen height.

The image is still deformed greatly in such a stretching mode as a whole. Only because of a uniform proportion, the visual image caused by the deformation is weakened.

In step S314, the portions of the adjusted image in the upper edge and the lower edge are longitudinally stretched to overspread the screen of the display device.

Most of the positions in the middle of the image are retained in accordance with the original aspect ratio in such stretching mode, which may ensure the image quality well. Certainly, to adapt to the ratio of the screen, the stretched portion is located at the edge of the image. The image quality of the whole image is not greatly affected by the deformation of the edge position. The quality of the original image is retained at the greatest extend in such mode.

### Sixth Embodiment

FIG. 9 is a flow chart of a method according to a sixth embodiment of the present application. The edge stretch mode of the step S314 in the fifth embodiment is specifically explained.

FIG. 9 shows the method, including the following steps.

In step S3140, an upper stretching boundary and a lower stretching boundary are respectively configured in the upper edge and the lower edge of the image according to the ratio of the portion from the upper edge and the lower edge of the image to the upper edge and the lower edge of the screen in the image height of the video source.

The greater the ratio is, the larger the area needs to be stretched. The compressed image in this portion is too stretched if the image distributed for stretching is relatively small. The stretched image and the image with normal aspect ratio are spliced, which makes the whole image very asymmetric. Therefore, the greater the ratio is, the more partial the upper stretching boundary and the lower stretching boundary is to the center of the screen. That is, it is required to distribute more images for stretching. However, the upper stretching boundary and the lower stretching boundary are also not partial to the center of the screen without limit. The image in the center of the screen is most important, which needs to ensure the portion of the center of the screen is displayed with the original aspect ratio.

In step S3142, the portion of the image from the upper stretching boundary and the lower stretching boundary to the upper edge and the lower edge of the image is correspondingly stretched to the upper edge and the lower edge of the screen from the upper stretching boundary and the lower stretching boundary.

The image stretching ratio from the upper stretching boundary and the lower stretching boundary to the upper edge and the lower edge of the screen is correspondingly increased during stretching, so as to ensure the smooth transition of the image of the video source along a direction from the center of the screen to the edge of the screen in the upper stretching boundary and the lower stretching boundary. In this way, for the portion of the stretched image between the upper stretching boundary and the lower stretching boundary, the image is not deformed. The closer the portion of the stretched image outside the upper stretching boundary and the lower stretching boundary is to the edge of the screen of the display device, the higher the deformation degree of the image is.

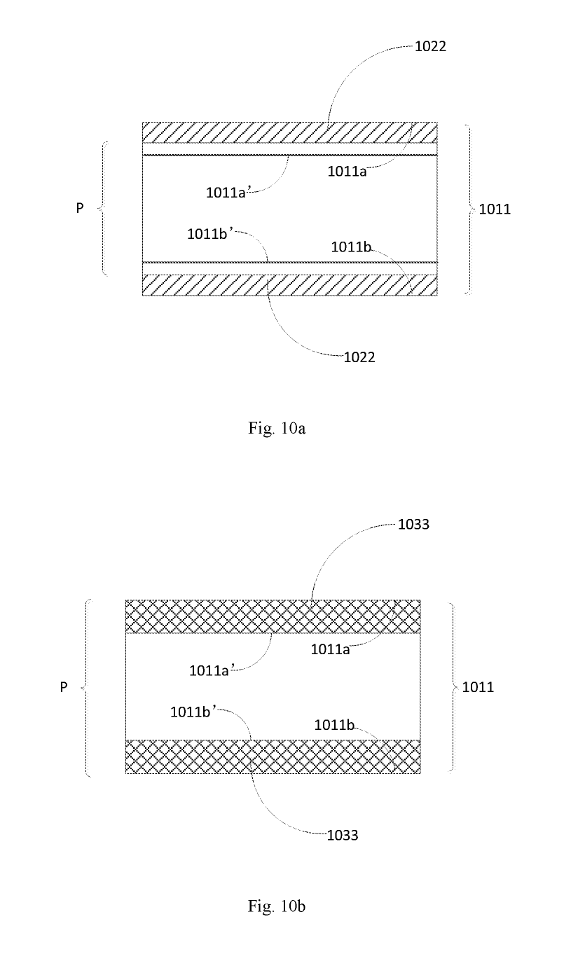

For instance, as shown in FIG. 10a, an upper edge and a lower edge of a screen 1011 in the figure are 1011a and 1011b respectively. A shaded portion 1022 is a portion in the screen 1011 without being filled by a image P of the video source. The upper edge and the lower edge of the image P are configured with an upper compression boundary 1011a′ and a lower compression boundary 1011b′ respectively. The upward image from the 1011a′ is stretched to cover between the 1011a′ and the 1011a. The downward image from the 1011b′ is stretched to cover between the 1011b′ and the 1011b. It is shown in FIG. 10b after stretching. A shaded portion 1033 in the figure is a portion stretched to fill in the screen 1011. For the portion between the upper compression boundary 1011a′ and the lower compression boundary 1011b′, the image is not deformed. For the portion outside the upper compression boundary 1011a′ and the lower compression boundary 1011b′, the closer the portion is to the upper edge 1011a and the lower edge 1011b, the higher the deformation degree of the image is. The image compression ratio from the upper compression boundary 1011a′ to the upper edge 1011a of the screen is correspondingly increased. The image compression ratio from the lower compression boundary 1011b′ to the lower edge 1011b of the screen is correspondingly increased. In this way, it may ensure the smooth transition of the image of the video source along a direction from the center of the screen to the edge of the screen in the upper compression boundary 1011a′ and the lower compression boundary 1011b′. The image is not changed abruptly.

Most of the positions in the middle of the image are retained in accordance with the original aspect ratio by applying the technical solution above, which may ensure the image quality well. Certainly, to adapt to the ratio of the screen, the stretched portion is located at the edge of the image. The image quality of the whole image is not greatly affected by the deformation of the edge position. The texture of original image is retained at the greatest extend in such mode.

### Seventh Embodiment

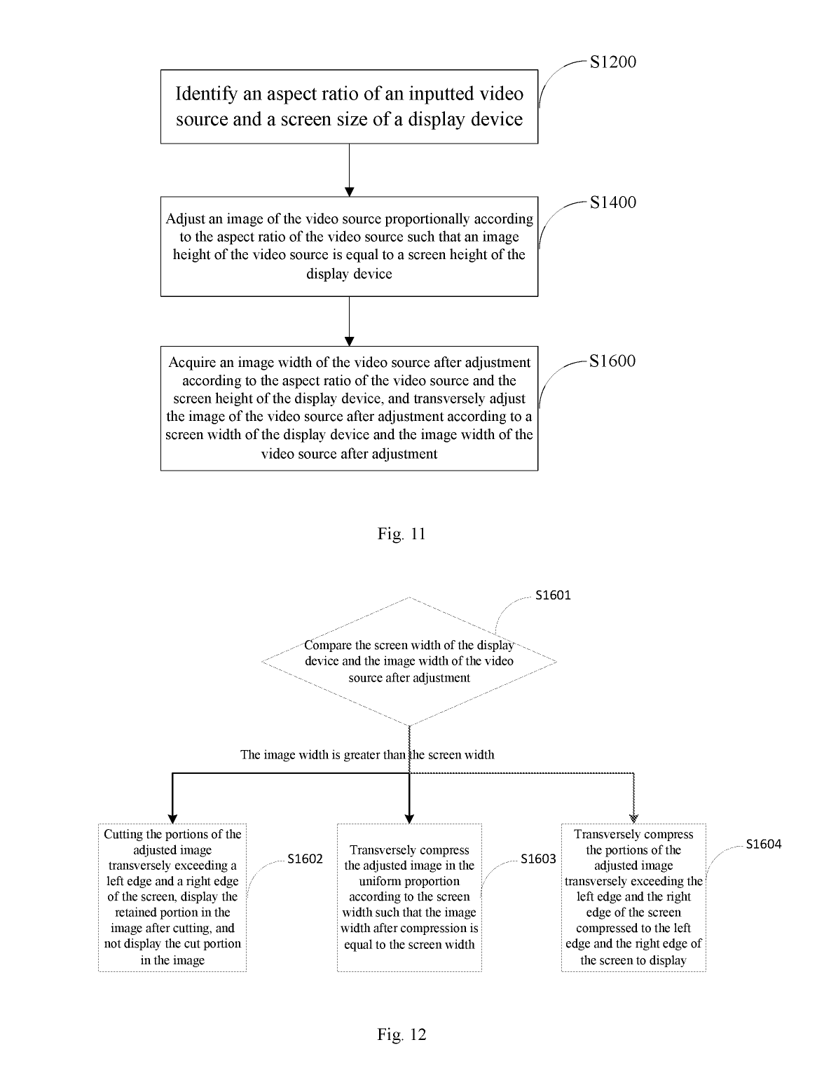

FIG. 11 is a flow chart of a method according to a seventh embodiment of the present application.

FIG. 11 shows a method for adjusting aspect ratio of smart televisions provided by the embodiment of the present application, including the following steps.

In step S1200, an aspect ratio of an input video source and a screen size of a display device are identified.

The aspect ratio of the video source generally refers to the width-to-height ratio of image here. Certainly, the aspect ratio described in the present application is not limited to the width-to-height ratio of image. And other parameter capable of uniquely determining the aspect ratio relation is also the aspect ratio described in the present application.

The width-to-height ratio of image refers to the ratio of the transverse width to the longitudinal height of the original video image. Moreover, the screen of the display device also has a width-to-height ratio of display screen. The width-to-height ratio of display screen refers to the ratio of the transverse width to the longitudinal height of the screen. In the actual experience, the width-to-height ratio of image does not always adapt to the width-to-height ratio of display screen. Therefore, black edges mainly appear at the left side and the right side of the screen, between the image of the video source and the screen, when broadcasting in the screen of the display device after adjusting the image of the video source in the existing mode. The black edges at the left side and the right side drags a user from a watching motion and scene that is just cultivated, which extremely affect the user experience.

The screen size of the display device generally refers to a screen height and a screen width. Certainly, the screen size described in the present application is not limited to it. Other parameters capable of uniquely determining the screen size, such as a screen diagonal length, are also part of the screen size described in the present application.

In step S1400, a image of the video source is adjusted proportionally according to the aspect ratio of the video source such that a image height of the video source is equal to a screen height of the display device.

The image of the video source is adjusted proportionally such that the image height to be equal to the screen height of the display device. In this way, there are three situations for the adjusted image as follows:

1) when the image width is greater than the screen width, this explains that the aspect ratio (width-to-height ratio) of the video source is greater than the screen ratio (width-to-height ratio). The image of the video source is flat with respect to the screen. And the image of the video source after adjustment transversely exceeds the left and the right of the screen of the display device;

2) when the image width is less than the screen width, this explains that the aspect ratio (width-to-height ratio) of the video source is greater than the screen ratio (width-to-height ratio). The image of the video source is lanky with respect to the screen. The image of the video source after adjustment is unable to transversely fill in the screen of the display device, leaving borders at the left and right of the screen; and

3) when the image width is equal to the screen width, this explains that the aspect ratio (width-to-height ratio) of the video source is equal to the screen ratio (width-to-height ratio). The image of the video source after adjustment also transversely fills in the screen of the display device just in time.

In step S1600, a image width of the video source after adjustment is acquired according to the aspect ratio of the video source and the screen height of the display device. And the image of the video source after adjustment is transversely adjusted according to a screen width of the display device and the image width of the video source after adjustment.

The image height of the video source after adjustment is equal to the screen height of the display device. Therefore, the adjustment may be accomplished according to the image ratio of the video source and the screen height of the display device that is, according to the image height of the video source after adjustment and the aspect ratio of the video source. Although the screen height of the display device and the aspect ratio have been acquired in the step S1200, it needs to wait the adjustment result of the step S1400 before the step S1600 is performed. This is because that the adjustment in the step S1400 is to scale the image proportionally. The adjustment in the step S1600 needs to compress and stretch the image, which is damage to the image quality.

Through the step S1400, the embodiment of the present application may make the video to longitudinally fill in the screen to remove the black edges at the upper edge and the lower edge of the screen longitudinally. However, three situations in the step S1400 may occur in the transverse direction. The image width of the video source needs to be adjusted in the step to adjust the image of the video source to accord with the screen size. For the situation of the image exceeding the screen in the first situation, the whole image needs to be compressed, or particularly, the exceeded portion needs to be compressed. Certainly, the exceeded portion may also be cut. For the situation of the image incapable of transversely filling in the screen in the second situation, the whole image needs to be stretched, or the edge portion of the image needs to be stretched. For the third situation, the aspect ratio is fit with the screen ratio. The screen will be transversely filled in while the screen is longitudinally filled in to achieve the best effect of maintaining the aspect ratio and broadcasting in full screen. The re-adjustment does not need to be performed at this moment.

### Eighth Embodiment

FIG. 12 is a flow chart of a method according to an eighth embodiment of the present application. It is an adjustment method for the situation that the image of the video source after adjustment transversely exceeds at the left and the right of the screen of the display device when the image height of the video source is equal to the screen height of the display device and after the image of the video source is adjusted in the equal proportion.

FIG. 12 shows the method, including the following steps.

In step S1601, the screen width of the display device and the image width of the video source after adjustment are compared. When the image width is greater than the screen weight, step S1602 or step S1603 or step S1604 is performed.

In step S1602, the portions of the adjusted image transversely exceeding a left edge and a right edge of the screen are cut, the retained portion in the image after cutting is displayed, and the cut portion in the image is not displayed.

The image with the original aspect ratio is completely retained for the displayed image in such cutting mode. However, the user will omit the images filled in the image during the course of watching if the cut portion is not displayed, which causes the incomplete experience during the course of watching. If the image information is focused in the middle position, such mode is still preferable.

In step S1603, the adjusted image is transversely compressed in the uniform proportion according to the screen width such that the image width after compression is equal to the screen width.

The image is still deformed greatly as a whole in such compression mode. Only because of a uniform proportion, the visual image caused by the deformation is weakened.

In step S1604, the portions of the adjusted image transversely exceeding the left edge and the right edge of the screen are transversely compressed to the left edge and the right edge of the screen to display.

Most of the positions in the middle of the image are retained in accordance with the original aspect ratio by such compression mode, which may ensure the image quality well. Of course, to adapt to the ratio of the screen, the compressed portion is located at the edge of the image. The image quality of the whole image is not greatly affected by the deformation of the edge position. The quality feeling of original image is retained to the greatest extend in such mode.

Aiming at the accessed video source, the image is adjusted by taking the longitudinal direction as a standard through the application of the technical solution above. The transverse image is preferably ensured to be adjusted in respectively suitable mode according to different final adjustment effects under a condition that the longitudinal direction is fit with the screen size, which makes the final image to fill in the whole screen.

### Ninth Embodiment

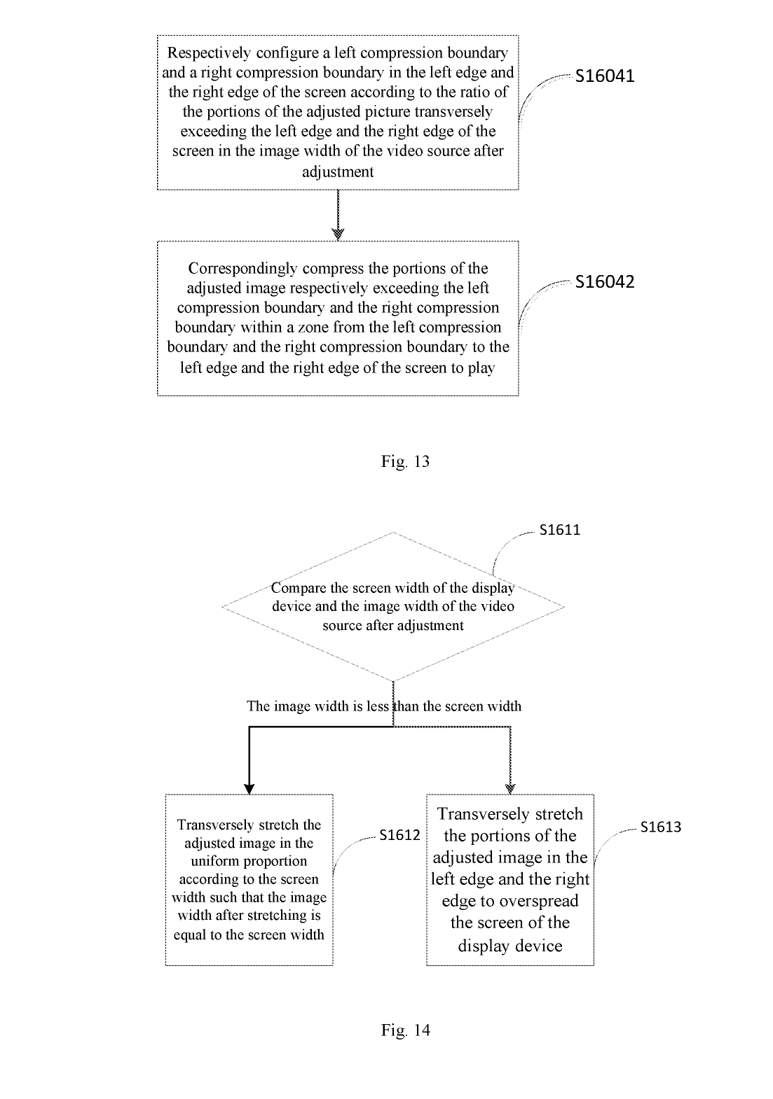

FIG. 13 is a flow chart of a method according to a ninth embodiment of the present application. The edge compression mode of the step S1604 in the third embodiment is specifically explained.

FIG. 13 shows the method, including the following steps.

In step S16041, a left compression boundary and a right compression boundary are respectively configured in the left edge and the right edge of the screen according to the ratio of the portions of the adjusted image transversely exceeding the left edge and the right edge of the screen in the image width of the video source after adjustment.

The greater the ratio is, the larger the area needs to be compressed. The compressed image in this portion is too compact if the assigned portion for the compressed image is relatively small. The compressed image and the image with normal aspect ratio are spliced, which makes the whole image very asymmetric. Therefore, the greater the ratio is, the more partial the left compression boundary and the right compression boundary is to the center of the screen. That is, more space needs to be left for the compressed image, and the area of the image to be compressed is also increased correspondingly. However, the left compression boundary and the right compression boundary are also not partial to the center of the screen without limit. The image in the center of the screen is most important, which needs to ensure the portion of the center of the screen is displayed with the original aspect ratio.

In step S16042, the portions of the adjusted image respectively exceeding the left compression boundary and the right compression boundary are correspondingly compressed within a zone from the left compression boundary and the right compression boundary to the left edge and the right edge of the screen to display.

The image compression ratio from the left compression boundary and the right compression boundary to the left edge and the right edge of the screen is correspondingly increased during compression, so as to ensure the smooth transition of the image of the video source along a direction from the center of the screen to the edge of the screen in the left compression boundary and the right compression boundary. In this way, for the portion of the compressed image between the left compression boundary and the right compression boundary, the image is not deformed. The closer the portion of the compressed image outside the left compression boundary and the right compression boundary is to the edge of the screen, the higher the deformation degree of the image is.

Most of the positions in the middle of the image are retained in accordance with the original aspect ratio by applying the technical solution above, which may ensure the image quality well. Of course, to adapt to the ratio of the screen, the compressed portion is located at the edge of the image. The image quality of the whole image is not greatly affected by the deformation of the edge position. The quality of original image is retained at the greatest extend in such mode.

### Tenth Embodiment

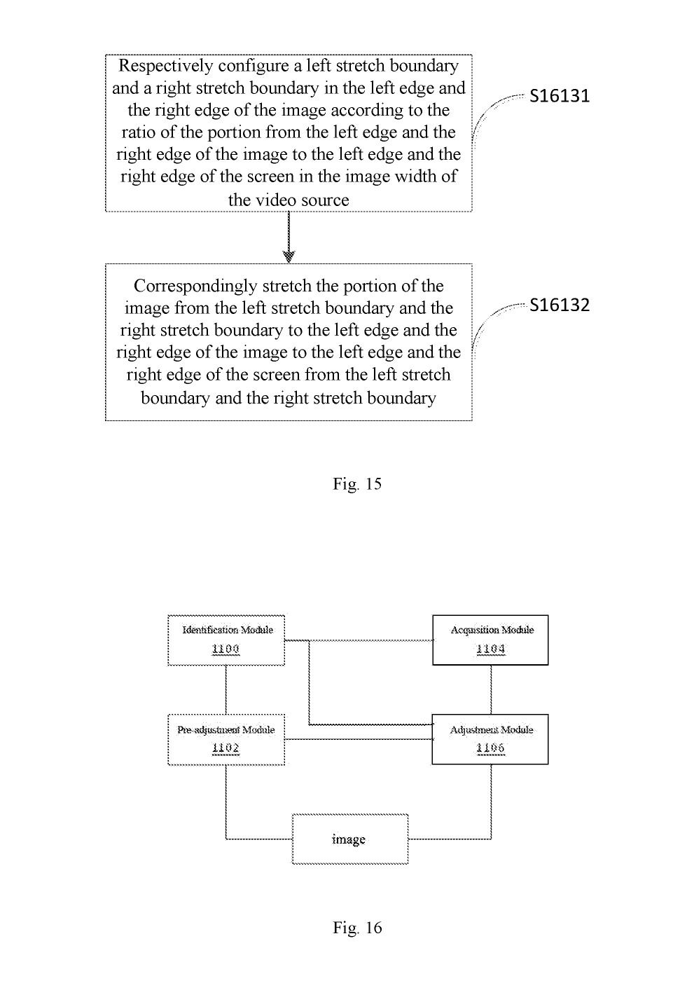

FIG. 14 is a flow chart of a method according to a tenth embodiment of the present application. It is aiming at the situation that the image of the video source after adjustment is unable to transversely fill in the screen when the image height of the video source is equal to the screen height of the display device and after the image of the video source is adjusted in the equal proportion.

FIG. 14 shows the method, including the following steps.

In step S1611, the screen width of the display device and the image width of the video source after adjustment are compared. When the image width is less than the screen weight, step S1612 or step S1613 is performed.

In step S1612, the adjusted image is transversely stretched in the uniform proportion according to the screen width such that the image width after stretching is equal to the screen width.

The image is still deformed greatly as a whole in such a stretching mode. Only because of a uniform proportion, the visual image caused by the deformation is weakened.

In step S1613, the portions of the adjusted image in the left edge and the right edge are transversely stretched to overspread the screen of the display device.

The most of positions in the middle of the image are retained in accordance with the original aspect ratio in such stretching mode, which may ensure the image quality well. Of course, to adapt to the ratio of the screen, the stretched portion is located at the edge of the image. The image quality of the whole image is not greatly affected by the deformation of the edge position. The quality feeling of original image is retained to the greatest extend in such mode.

Aiming at the accessed video source, the image is adjusted by taking the longitudinal direction as a standard through the application of the technical solution above. The transverse image is preferably ensured to be adjusted in respectively suitable mode according to different final adjustment effects under a condition that the longitudinal direction is fit with the screen size. The black edges of the video at the upper edge, the lower edge, the left edge and the right edge of the broadcast interface of the screen are finally removed in an automatic manner, and the video may be broadcasted in the screen in a state of full screen. While a preferable watch effect is obtained, a user is exempted from a trouble of manual adjustment at the same time, which simplifies a user operation and improves user experiences.

### Eleventh Embodiment

FIG. 15 is a flow chart of a method according to an eleventh embodiment of the present application. The edge stretch mode of the step S1613 in the fifth embodiment is specifically explained.

FIG. 15 shows the method, including the following steps.

In step S16131, a left stretch boundary and a right stretch boundary are respectively configured in the left edge and the right edge of the image according to the ratio of the portion from the left edge and the right edge of the image to the left edge and the right edge of the screen in the image width of the video source.

The greater the ratio is, the larger the area needs to be stretched. The compressed image in this portion is too stretched if the image assigned for stretching is relatively small. The stretched image and the image with normal aspect ratio are spliced, which makes the whole image very asymmetric. Therefore, the greater the ratio is, the more partial the left stretch boundary and the right stretch boundary is to the center of the screen, that is, it is required to assign more images for stretching. However, the left stretch boundary and the right stretch boundary are also not partial to the center of the screen without limit. The image in the center of the screen is most important, which needs to ensure the portion of the center of the screen is displayed with the original aspect ratio.

In step S16132, the portion of the image from the left stretch boundary and the right stretch boundary to the left edge and the right edge of the image is correspondingly stretched to the left edge and the right edge of the screen from the left stretch boundary and the right stretch boundary.

The image stretching ratio from the left stretch boundary and the right stretch boundary to the left edge and the right edge of the screen is correspondingly increased during stretching, so as to ensure the smooth transition of the image of the video source along a direction from the center of the screen to the edge of the screen in the left stretch boundary and the right stretch boundary. In this way, for the portion of the stretched image between the left stretch boundary and the right stretch boundary, the image is not deformed. The closer the portion of the stretched image outside the left stretch boundary and the right stretch boundary is to the edge of the screen of the display device, the higher the deformation degree of the image is.

Most of the positions in the middle of the image are retained in accordance with the original aspect ratio by applying the technical solution above, which may ensure the image quality well. Of course, to adapt to the ratio of the screen, the stretched portion is located at the edge of the image. The image quality of the whole image is not greatly affected by the deformation of the edge position. The quality of original image is retained at the greatest extend in such mode.

### Twelfth Embodiment

FIG. 16 is a flow chart of a device according to a twelfth embodiment of the present application.

FIG. 16 shows a device provided by the embodiment of the present application, including an identification module 1100, a pre-adjustment module 1102, an acquisition module 1104, and an adjustment module 1106.

The identification module 1100 is configured to identify an aspect ratio of an input video source and a screen size of a display device.

The pre-adjustment module 1102 is coupled with the identification module 1100 and is configured to adjust a image of the video source proportionally according to the aspect ratio of the video source such that a image width of the video source is equal to a screen width of the display device.

The acquisition module 1104 is coupled with the identification module 1100 and is configured to acquire a image height of the video source after adjustment according to the aspect ratio of the video source and the screen width of the display device.

The adjustment module 1106 is coupled with the identification module 1100, the acquisition module 1104 and the pre-adjustment module 1102 respectively. And it is configured to longitudinally adjust the image of the video source after adjustment according to a screen height of the display device and the image height of the video source after adjustment.

In the embodiment, the aspect ratio of the video source generally refers to the width-to-height ratio of image here. Certainly, the aspect ratio described in the present application is not limited to the width-to-height ratio of image, and other parameter capable of uniquely determining the aspect ratio relation is also the aspect ratio described in the present application. The screen size of the display device generally refers to a screen height and a screen width. Of course, the screen size described in the present application is not limited to it. Other parameters capable of uniquely determining the screen size, such as a screen diagonal length, are also part of the screen size described in the present application.

The image of the video source is adjusted by the pre-adjustment module 1102 proportionally such that the image width is equal to the screen width of the display device. In this way, there are three situations for the adjusted image as follows:

1) when the image height is greater than the screen height, as shown in FIG. 4a, this explains that the aspect ratio (width-to-height ratio) of the video source is less than the screen ratio (width-to-height ratio). The image of the video source is lanky with respect to the screen. The image of the video source after adjustment longitudinally exceeds above and below the screen of the display device;

2) when the image height is less than the screen height, as shown in FIG. 4b, this explains that the aspect ratio (width-to-height ratio) of the video source is greater than the screen ratio (width-to-height ratio). The image of the video source is flat with respect to the screen. The image of the video source after adjustment is unable to longitudinally fill in the screen of the display device, leaving borders at the left and right of the screen; and

3) when the image height is equal to the screen height, as shown in FIG. 4c, this explains that the aspect ratio (width-to-height ratio) of the video source is equal to the screen ratio (width-to-height ratio). The image of the video source after adjustment also longitudinally fills in the screen of the display device just in time.

The image width of the video source adjusted by the pre-adjustment module 1102 is equal to the screen width of the display device. Therefore, the adjustment may be accomplished by the adjustment module 1106 according to the image ratio of the video source and the screen width of the display device that is according to the image width of the video source after adjustment and the aspect ratio of the video source. Although the screen width of the display device and the aspect ratio have been acquired by the identification module 1100 and the adjustment module 1106 has also been notified, it needs for the adjustment module 1106 to wait the adjustment result of the pre-adjustment module 1102. This is because that the adjustment of the pre-adjustment module 1102 is to scale the image proportionally. The adjustment of the adjustment module 1106 needs to compress and stretch the image, which downgrades the image quality.

Corresponding to the situation of 1), the adjustment module 1106 is further configured to, when the image height is greater than the screen height, cut the portion of the adjusted image longitudinally exceeding an upper edge and a lower edge of a screen, display the retained portion in the image after cutting, and not display the cut portion in the image; or longitudinally compress the adjusted image in the uniform proportion according to the screen height such that the image height after compression is equal to the screen height; or longitudinally compress the portion of the adjusted image longitudinally exceeding the upper edge and the lower edge of the screen to the upper edge and the lower edge of the screen to display. Certainly, if the aspect ratio is just fit with the screen ratio, the screen is longitudinally filled in while the screen is transversely filled in to achieve the best effect of maintaining the aspect ratio and broadcasting in full screen. The re-adjustment does not need to be performed by the adjustment module 1106 at this moment.

Particularly, for the situation of longitudinally compressing the portion of the adjusted image longitudinally exceeding the upper edge and the lower edge of the screen to the upper edge and the lower edge of the screen to display, the adjustment module 1106 is further configured to respectively configure an upper compression boundary and a lower compression boundary in the upper edge and the lower edge of the screen according to the ratio of the portion of the adjusted image longitudinally exceeding the upper edge and the lower edge of the screen in the image height of the video source after adjustment; and correspondingly compress the portions of the adjusted image respectively exceeding the upper compression boundary and the lower compression boundary within a zone from the upper compression boundary and the lower compression boundary to the upper edge and the lower edge of the screen to display. The higher the ratio is, the more partial the upper compression boundary and the lower compression boundary is to the center of the screen, without exceeding a preset limit position. It should be noted that the image compression ratio from the upper compression boundary and the lower compression boundary to the upper edge and the lower edge of the screen is correspondingly increased during the compression of the adjustment module 1106, so as to ensure the smooth transition of the image of the video source along a direction from the center of the screen to the edge of the screen in the upper compression boundary and the lower compression boundary. After the compression of the adjustment module 1106, for the portion of the image between the upper compression boundary and the lower compression boundary, the image is not deformed. After the compression of the adjustment module, the closer the portion of the image outside the upper compression boundary and the lower compression boundary is to the edge of the screen, the higher the deformation degree of the image is.

Corresponding to the situation of 2), the adjustment module 1106 is further configured to, when the image height is less than the screen height, fill a black edge respectively in the portion of the adjusted image from the upper edge to the lower edge of the image to the upper edge and the lower edge of the screen; or, longitudinally stretch the adjusted image in a uniform proportion according to the screen height such that the image height after stretching is equal to the screen height; or longitudinally stretch the portion of the adjusted image in the upper edge and the lower edge to overspread the screen of the display device. Certainly, if the aspect ratio is just fit with the screen ratio, the screen is longitudinally filled in while the screen is transversely filled in to achieve the best effect of maintaining the aspect ratio and broadcasting in full screen. The re-adjustment does not need to be performed by the adjustment module 1106 at this moment.

Particularly, for the situation of longitudinally stretching the portion of the adjusted image in the upper edge and the lower edge to overspread the screen of the display device, the adjustment module 1106 is further configured to respectively configure an upper stretching boundary and a lower stretching boundary in the upper edge and the lower edge of the image according to the ratio of the portion from the upper edge and the lower edge of the image to the upper edge and the lower edge of the screen in the image height of the video source; and correspondingly stretch the portion of the image from the upper stretching boundary and the lower stretching boundary to the upper edge and the lower edge of the image to the upper edge and the lower edge of the screen from the upper stretching boundary and the lower stretching boundary. The higher the ratio is, the more partial the upper stretching boundary and the lower stretching boundary is to the center of the screen, without exceeding a preset limit position. It should be noted that the image stretching ratio from the upper compression boundary and the lower compression boundary to the upper edge and the lower edge of the screen is correspondingly increased during the stretching of the adjustment module 1106, so as to ensure the smooth transition of the image of the video source along a direction from the center of the screen to the edge of the screen in the upper stretching boundary and the lower stretching boundary. After stretching of the adjustment module 1106, for the portion of the image between the upper stretching boundary and the lower stretching boundary, the image is not deformed. After stretching of the adjustment module, the closer the portion of the image outside the upper stretching boundary and the lower stretching boundary is to the edge of the screen of the display device, the higher the deformation degree of the image is.

The identification module 1100 is further configured to acquire a pixel ratio and a resolution ratio of the image of the video source, wherein the pixel ratio is a ratio of a transverse width to a longitudinal height of a single pixel, and the resolution ratio is the ratio of the horizontal number of pixels to the longitudinal number of pixels of the video; and it is configured to calculate a product value of the pixel ratio and the resolution ratio of the image of the video source, wherein the product value is the aspect ratio of the video source.

Those skilled in the art may clearly understand that, to describe conveniently and simply, it is only illustrated by taking the division of each functional module above as an example for the purpose of convenient and simple description. In practical application, the foregoing function may be assigned to be finished by different functional modules according to requirements. That is, the interior of the apparatus is divided into different functional modules so as to finish all or part of the functions described above. For specific working processes of the apparatus described in the foregoing, reference may be made to corresponding processes in the foregoing method embodiments, which will not be elaborated herein.

### Thirteenth Embodiment

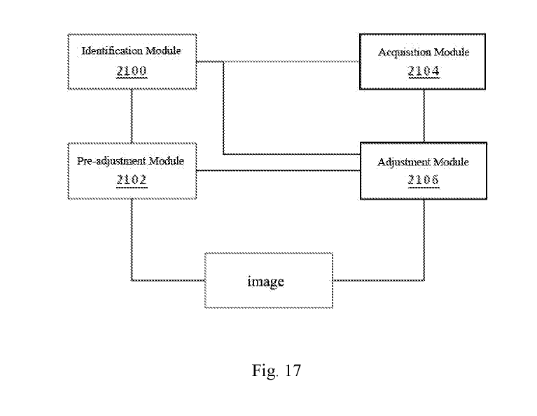

FIG. 17 is a flow chart of a device according to a thirteenth embodiment of the present application.

FIG. 17 shows a device provided by the embodiment of the present application, including an identification module 2100, a pre-adjustment module 2102, an acquisition module 2104, and an adjustment module 2106.

The identification module 2100 is configured to identify an aspect ratio of an input video source and a screen size of a display device.

The pre-adjustment module 2102 is coupled with the identification module 2100 and is configured to adjust a image of the video source proportionally according to the aspect ratio of the video source such that a image height of the video source is equal to a screen height of the display device.

The acquisition module 2104 is coupled with the identification module 2100 and is configured to acquire a image width of the video source after adjustment according to the aspect ratio of the video source and the screen height of the display device.

The adjustment module 2106 is coupled with the identification module 2100, the acquisition module 2104 and the pre-adjustment module 2102 respectively, and it is configured to transversely adjust the image of the video source after adjustment according to a screen width of the display device and the image width of the video source after adjustment.

In the embodiment, the aspect ratio of the video source generally refers to the width-to-height ratio of image here. Certainly, the aspect ratio described in the present application is not limited to the width-to-height ratio of image, and other parameter capable of uniquely determining the aspect ratio relation is also the aspect ratio described in the present application. The screen size of the display device generally refers to a screen height and a screen width. Of course, the screen size described in the present application is not limited to it. Other parameters capable of uniquely determining the screen size, such as a screen diagonal length, are also part of the screen size described in the present application.

The image of the video source is adjusted by the pre-adjustment module 2102 proportionally such that the image height is equal to the screen height of the display device. In this way, there are three situations for the adjusted image as follows:

1) when the image width is greater than the screen width, this explains that the aspect ratio (width-to-height ratio) of the video source is less than the screen ratio (width-to-height ratio). The image of the video source is lanky with respect to the screen. And the image of the video source after adjustment transversely exceeds the left and the right of the screen of the display device;

2) when the image width is less than the screen width, this explains that the aspect ratio (width-to-height ratio) of the video source is greater than the screen ratio (width-to-height ratio). The image of the video source is flat with respect to the screen. And the image of the video source after adjustment is unable to transversely fill in the screen of the display device, leaving spaces at the left and the right of the screen; and

3) when the image width is equal to the screen width, this explains that the aspect ratio (width-to-height ratio) of the video source is equal to the screen ratio (width-to-height ratio). The image of the video source after adjustment also transversely fills in the screen of the display device just in time.

The image height of the video source after adjustment by the pre-adjustment module 2102 is equal to the screen height of the display device. Therefore, the adjustment may be finished by the adjustment module 2106 according to the image ratio of the video source and the screen height of the display device that is equivalent to according to the image height of the video source after adjustment and the aspect ratio of the video source. Although the screen height of the display device and the aspect ratio have been acquired by the identification module 2100 and the adjustment module 2106 has also been notified, it needs for the adjustment module 2106 to wait the adjustment result of the pre-adjustment module 2102. This is because that the adjustment of the pre-adjustment module 2102 is to scale the image proportionally. The adjustment of the adjustment module 2106 needs to compress and stretch the image, which downgrade the image quality.

Corresponding to the situation of 1), the adjustment module 2106 is further configured to, when the image width is greater than the screen width, cut the portion of the adjusted image transversely exceeding a left edge and a right edge of a screen, display the retained portion in the image after cutting, and not display the cut portion in the image; or transversely compress the adjusted image in the uniform proportion according to the screen width such that the image width after compression is equal to the screen width; or transversely compress the portion of the adjusted image transversely exceeding the left edge and the right edge of the screen to the left edge and the right edge of the screen to display. Certainly, if the aspect ratio is just fit with the screen ratio, the screen will be transversely filled in while the screen is longitudinally filled in to achieve the best effect of maintaining the aspect ratio and broadcasting in full screen. The re-adjustment does not need to be performed by the adjustment module 2106 at this moment.

Particularly, for the situation of transversely compressing the portion of the adjusted image transversely exceeding the left edge and the right edge of the screen to the left edge and the right edge of the screen to display, the adjustment module 2106 is further configured to respectively configure a left compression boundary and a right compression boundary in the left edge and the right edge of the screen according to the ratio of the portion of the adjusted image transversely exceeding the left edge and the right edge of the screen in the image width of the video source after adjustment; and correspondingly compress the portions of the adjusted image respectively exceeding the left compression boundary and the right compression boundary within a zone from the left compression boundary and the right compression boundary to the left edge and the right edge of the screen to display. The higher the ratio is, the more partial the left compression boundary and the right compression boundary is to the center of the screen, without exceeding a preset limit position. It should be noted that the image compression ratio from the left compression boundary and the right compression boundary to the left edge and the right edge of the screen is correspondingly increased during the compression of the adjustment module 2106, so as to ensure the smooth transition of the image of the video source along a direction from the center of the screen to the edge of the screen in the left compression boundary and the right compression boundary. After the compression of the adjustment module 2106, for the portion of the image between the left compression boundary and the right compression boundary, the image is not deformed; and after the compression of the adjustment module, the closer the portion of the image outside the left compression boundary and the right compression boundary is to the edge of the screen, the higher the deformation degree of the image is.

Corresponding to the situation of 2), the adjustment module 2106 is further configured to, when the image width is less than the screen width, transversely stretch the adjusted image in the uniform proportion according to the screen width such that the image width after stretching is equal to the screen width; or transversely stretch the portion of the adjusted image in the left edge and the right edge to overspread the screen of the display device. Certainly, if the aspect ratio is just fit with the screen ratio, the screen is transversely filled in while the screen is longitudinally filled in to achieve the best effect of maintaining the aspect ratio and broadcasting in full screen. The re-adjustment does not need to be performed by the adjustment module 2106 at this moment.

Particularly, for the situation of transversely stretching the portion of the adjusted image in the left edge and the right edge to overspread the screen of the display device, the adjustment module 2106 is further configured to respectively configure a left stretch boundary and a right stretch boundary in the left edge and the right edge of the image according to the ratio of the portion from the left edge and the right edge of the image to the left edge and the right edge of the screen in the image width of the video source; and correspondingly stretch the portion of the image from the left stretch boundary and the right stretch boundary to the left edge and the right edge of the image to the left edge and the right edge of the screen from the left stretch boundary and the right stretch boundary. The higher the ratio is, the more partial the left stretch boundary and the right stretch boundary is to the center of the screen, without exceeding a preset limit position. It should be noted that the image stretching ratio from the left stretch boundary and the right stretch boundary to the left edge and the right edge of the screen is correspondingly increased during the stretching of the adjustment module 2106, so as to ensure the smooth transition of the image of the video source along a direction from the center of the screen to the edge of the screen in the left stretch boundary and the right stretch boundary. After stretching of the adjustment module 2106, for the portion of the image between the left stretch boundary and the right stretch boundary, the image is not deformed. After stretching of the adjustment module, the closer the portion of the image outside the left stretch boundary and the right stretch boundary is to the edge of the screen of the display device, the higher the deformation degree of the image is.

The identification module 2100 is further configured to acquire a pixel ratio and a resolution ratio of the image of the video source, wherein the pixel ratio is a ratio of a transverse width to a longitudinal height of a single pixel, and the resolution ratio is the ratio of the horizontal number of pixels to the longitudinal number of pixels of the video; and it is configured to calculate a product value of the pixel ratio and resolution ratio of the image of the video source, wherein the product value is the aspect ratio of the video source.

Those skilled in the art may clearly understand that, to describe conveniently and simply, it is only illustrated by taking the division of each functional module above as an example for the purpose of convenient and simple description. In practical application, the foregoing function distribution may be finished by different functional modules according to requirements. That is, the interior of the apparatus is divided into different functional modules so as to finish all or part of the functions described above. For specific working processes of the apparatus described in the foregoing, reference may be made to corresponding processes in the foregoing method embodiments, which will not be elaborated herein.

In several embodiments of the present disclosure, it should be understood that the disclosed device, and method may be implemented in other ways. For example, the device embodiments described above are only exemplary.

The modules described may or may not be physically separated from each other, and the parts shown as modules may be one or more physical units, that is, the parts may be located at the same place and may also be distributed to multiple different places. A part or all of units may be selected according to the actual requirement to achieve the objectives of the solutions in the embodiments.

In addition, function units in the embodiments of the present disclosure may be integrated into a processing unit, or each unit exists singly and physically, or two or more units are integrated in one unit. The foregoing integrated unit may either be fulfilled using a hardware form, or be fulfilled using a software functional module form.

If the integrated unit is implemented in the form of a software function unit and is sold or used as an independent product, it may be stored in a readable storage medium. Based on such understanding, the technical solutions of the present disclosure essentially, or the part contributing to the prior art, or all or a part of the technical solutions may be implemented in the form of a software product. The software product is stored in a storage medium and includes several instructions for instructing a device (which may be a single chip, a chip and so on) or a processor to execute all or a part of steps of the methods described in the embodiments of the present disclosure. While the abovementioned storage medium includes: any medium that is capable of storing program codes, such as a USB drive, a mobile hard disk drive, a read-only memory (ROM), a random access memory (RAM), a magnetic disk, or an optical disk.

The above description is merely detailed implementation manner of the present disclosure, but not intended to limit the protection scope of the present disclosure. Any changes or replacements easily figured out by those skilled in the art without departing from the technical scope disclosed by the present disclosure shall all fall within the protection scope of the present disclosure. Therefore, the protection scope of the present disclosure shall be subjected to the protection scope of the claims.

### INDUSTRIAL APPLICABILITY

According to the method and the device for adjusting the ratio aspect of the smart televisions provided by the present application, the transverse black edges of the video in the broadcast interface of the screen may be removed automatically such that the aspect ratio is more suitable for watching no matter which aspect ratio is provided in the currently-accessed video. While a preferable watching effect is obtained, a user is exempted from a trouble of manual adjustment, which simplifies a user operation and improves user experiences.

1. A method for adjusting an aspect ratio of a smart TV, characterized by comprising:
identifying an aspect ratio of an inputted video source and a screen size of a display device;
adjusting a image of the video source proportionally according to an aspect ratio of the video source such that a image width of the video source is equal to a screen width of the display device; and
acquiring a image height of the video source after adjustment according to the aspect ratio of the video source and the screen width of the display device, and longitudinally adjusting the image of the video source after adjustment according to a screen height of the display device and the image height of the video source after adjustment.

2. The method for adjusting the aspect ratio according to claim 1, characterized in that, longitudinally adjusting the image of the video source after adjustment according to the screen height of the display device and the image height of the video source after adjustment further comprises:
when the image height is greater than the screen height, cutting portions of the adjusted image longitudinally exceeding an upper edge and a lower edge of a screen, displaying a retained portion in the image after cutting, and not displaying the cut portion in the image.

3. The method for adjusting the aspect ratio according to claim 1, characterized in that, longitudinally adjusting the image of the video source after adjustment according to the screen height of the display device and the image height of the video source after adjustment further comprises:
when the image height is greater than the screen height, longitudinally compressing the adjusted image in a uniform proportion according to the screen height such that the image height after compression is equal to the screen height.

4. The method for adjusting the aspect ratio according to claim 1, characterized in that, longitudinally adjusting the image of the video source after adjustment according to the screen height of the display device and the image height of the video source after adjustment further comprises:
when the image height is greater than the screen height, longitudinally compressing portions of the adjusted image longitudinally exceeding an upper edge and an lower edge of the screen to the upper edge and the lower edge of the screen to display.

5. The method for adjusting the aspect ratio according to claim 4, characterized in that, longitudinally compressing the portions of the adjusted image longitudinally exceeding the upper edge and the lower edge of the screen to the upper edge and the lower edge of the screen to display further comprises:
respectively configuring an upper compression boundary and a lower compression boundary in the upper edge and the lower edge of the screen according to a ratio of the portions of the adjusted image longitudinally exceeding the upper edge and the lower edge of the screen in the image height of the video source after adjustment; and
correspondingly compressing the portions of the adjusted image respectively exceeding the upper compression boundary and the lower compression boundary within a zone from the upper compression boundary and the lower compression boundary to the upper edge and the lower edge of the screen to display.

6. The method for adjusting the aspect ratio according to claim 5, characterized in that,
a image compression ratio from the upper compression boundary and lower compression boundary to the upper edge and lower edge of the screen is correspondingly increased during compression, so as to ensure a smooth transition of the image of the video source along a direction from the center of the screen to the edge of the screen in the upper compression boundary and lower compression boundary.

7. The method for adjusting the aspect ratio according to claim 5 or 6, characterized in that,
for the portion of the compressed image between the upper compression boundary and the lower compression boundary, the image is not deformed; and the closer the portion of the compressed image outside the upper compression boundary and lower compression boundary is to the edge of the screen, the higher the deformation degree of the image is.

8. The method for adjusting the aspect ratio according to claim 5, characterized in that,
the higher the ratio is, the more partial the upper compression boundary and lower compression boundary is to the center of the screen, without exceeding a preset limit position.

9. The method for adjusting the aspect ratio according to claim 1, characterized in that, longitudinally adjusting the image of the video source after adjustment according to the screen height of the display device and the image height of the video source after adjustment further comprises:
when the image height is less than the screen height, filling a black edge respectively in the portion of the adjusted image from an upper edge and lower edge of the image to the upper edge and lower edge of the screen.

10. The method for adjusting the aspect ratio according to claim 1, characterized in that, longitudinally adjusting the image of the video source after adjustment according to the screen height of the display device and the image height of the video source after adjustment further comprises:
when the image height is less than the screen height, longitudinally stretching the adjusted image in a uniform proportion according to the screen height such that the stretched image height is equal to the screen height.

11. The method for adjusting the aspect ratio according to claim 1, characterized in that, longitudinally adjusting the image of the video source after adjustment according to the screen height of the display device and the image height of the video source after adjustment further comprises:
when the image height is less than the screen height, longitudinally stretching portions of the adjusted image in an upper edge and lower edge to overspread the screen of the display device.

12. The method for adjusting the aspect ratio according to claim 11, characterized in that, longitudinally stretching the portions of the adjusted image in the upper edge and lower edge to overspread the screen of the display device further comprises:
respectively configuring an upper stretching boundary and a lower stretching boundary in the upper edge and the lower edge of the image according to a ratio of the portion from the upper edge and the lower edge of the image to an upper edge and lower edge of the screen in the image height of the video source; and
correspondingly stretching the portion of the image from the upper stretching boundary and lower stretching boundary to the upper edge and lower edge of the image to the upper edge and the lower edge of the screen from the upper stretching boundary and the lower stretching boundary.

13. The method for adjusting the aspect ratio according to claim 12, characterized in that,
a image stretching ratio from the upper stretching boundary and lower stretching boundary to the upper edge and lower edge of the screen is correspondingly increased during stretching, so as to ensure a smooth transition of the image of the video source along a direction from the center of the screen to the edge of the screen in the upper stretching boundary and the lower stretching boundary.

14. The method for adjusting the aspect ratio according to claim 12 or 13, characterized in that,
for the portion of the stretched image between the upper stretching boundary and the lower stretching boundary, the image is not deformed; and the closer the portion of the stretched image outside the upper stretching boundary and lower stretching boundary is to the edge of the screen of the display device, the higher the deformation degree of the image is.

15. The method for adjusting the aspect ratio according to claim 12, characterized in that,
the higher the ratio is, the more partial the upper stretching boundary and lower stretching boundary is to the center of the screen, without exceeding a preset limit position.

16. The method for adjusting the aspect ratio according to claim 1, characterized in that, identifying the aspect ratio of the inputted video source further comprises:
acquiring a pixel ratio and a resolution ratio of the image of the video source; wherein the pixel ratio is a ratio of a transverse width to a longitudinal height of a single pixel, and the resolution ratio is a ratio of the horizontal number of pixels to the longitudinal number of pixels of the video; and
calculating a product value of the pixel ratio and the resolution ratio of the image of the video source, wherein the product value is the aspect ratio of the video source.

17. A computer-readable storage medium recording a program configured to execute the method for adjusting the aspect ratio according to any one of claims 1 to 16.

18. A method for adjusting aspect ratio of smart TV, characterized by comprising:
identifying an aspect ratio of an inputted video source and a screen size of a display device;
adjusting a image of the video source proportionally according to the aspect ratio of the video source such that a image height of the video source is equal to a screen height of the display device; and
acquiring a image width of the video source after adjustment according to the aspect ratio of the video source and the screen height of the display device, and transversely adjusting the image of the video source after adjustment according to a screen width of the display device and the image width of the video source after adjustment.

19. The method for adjusting the aspect ratio according to claim 18, characterized in that, transversely adjusting the image of the video source after adjustment according to the screen width of the display device and the image width of the video source after adjustment further comprises:
when the image width is greater than the screen width, cutting portions of the adjusted image transversely exceeding a left edge and a right edge of a screen, displaying a retained portion in the image after cutting, and not displaying the cut portions in the image.

20. The method for adjusting the aspect ratio according to claim 18, characterized in that, transversely adjusting the image of the video source after adjustment according to the screen width of the display device and the image width of the video source after adjustment further comprises:
when the image width is greater than the screen width, transversely compressing the adjusted image in a uniform proportion according to the screen height such that the compressed image width is equal to the screen width.

21. The method for adjusting the aspect ratio according to claim 18, characterized in that, transversely adjusting the image of the video source after adjustment according to the screen width of the display device and the image width of the video source after adjustment further comprises:
when the image width is greater than the screen width, transversely compressing portions of the adjusted image transversely exceeding a left edge and a right edge of the screen to a left edge and a right edge of the screen to display.

22. The method for adjusting the aspect ratio according to claim 21, characterized in that, transversely compressing the portions of the adjusted image transversely exceeding the left edge and the right edge of the screen to the left edge and the right edge of the screen to display further comprises:
respectively configuring a left compression boundary and a right compression boundary in the left edge and the right edge of the screen according to a ratio of the portions of the adjusted image transversely exceeding the left edge and the right edge of the screen to the image width of the video source after adjustment; and
correspondingly compressing the portions of the adjusted image respectively exceeding the left compression boundary and the right compression boundary within a zone from the left compression boundary and the right compression boundary to the left edge and the right edge of the screen to display.

23. The method for adjusting the aspect ratio according to claim 22, characterized in that,
a image compression ratio from the left compression boundary and right compression boundary to the left edge and right edge of the screen is correspondingly increased during compression, so as to ensure a smooth transition of the image of the video source along a direction from the center of the screen to the edge of the screen in the left compression boundary and right compression boundary.

24. The method for adjusting the aspect ratio according to claim 22 or 23, characterized in that,
for the portion of the adjusted image between the left compression boundary and the right compression boundary, the image is not deformed; and the closer the portion of the adjusted image outside the left compression boundary and the right compression boundary is to the edge of the screen, the higher the deformation degree of the image is.

25. The method for adjusting the aspect ratio according to claim 22, characterized in that,
the higher the ratio is, the more partial the left compression boundary and the right compression boundary is to the center of the screen, without exceeding a preset limit position.

26. The method for adjusting the aspect ratio according to claim 18, characterized in that, transversely adjusting the image of the video source after adjustment according to the screen width of the display device and the image width of the video source after adjustment further comprises:
when the image width is less than the screen width, transversely stretching the adjusted image in a uniform proportion according to the screen width such that the image width after stretching is equal to the screen width.

27. The method for adjusting the aspect ratio according to claim 18, characterized in that, transversely adjusting the image of the video source after adjustment according to the screen width of the display device and the image width of the video source after adjustment further comprises:
when the image width is less than the screen width, transversely stretching the portions of the adjusted image in the left edge and right edge to overspread the screen of the display device.

28. The method for adjusting the aspect ratio according to claim 27, characterized in that, transversely stretching the portions of the adjusted image in the left edge and the right edge to overspread the screen of the display device further comprises:
respectively configuring a left stretch boundary and a right stretch boundary in the left edge and the right edge of the image according to a ratio of the portion from the left edge and the right edge of the image to the left edge and the right edge of the screen in the image width of the video source; and
correspondingly stretching the portion of the image from the left stretch boundary and the right stretch boundary to the left edge and the right edge of the image to the left edge and the right edge of the screen from the left stretch boundary and the right stretch boundary.

29. The method for adjusting the aspect ratio according to claim 28, characterized in that,
a image stretching ratio from the left stretch boundary and right stretch boundary to the left edge and right edge of the screen is correspondingly increased during stretching, so as to ensure a smooth transition of the image of the video source along a direction from the center of the screen to the edge of the screen in the left stretch boundary and the right stretch boundary.

30. The method for adjusting the aspect ratio according to claim 28 or 29, characterized in that,
for the portion of the stretched image between the left stretch boundary and the right stretch boundary, the image is not deformed; and the closer the portion of the stretched image outside the left stretch boundary and the right stretch boundary is to the edge of the screen of the display device, the higher the deformation degree of the image is.

31. The method for adjusting the aspect ratio according to claim 28, characterized in that,
the higher the ratio is, the more partial the left stretch boundary and the right stretch boundary is to the center of the screen, without exceeding a preset limit position.

32. The method for adjusting the aspect ratio according to claim 18, characterized in that, identifying the aspect ratio of the input video source further comprises:
acquiring a pixel ratio and a resolution ratio of the image of the video source; wherein the pixel ratio is a ratio of a transverse width to a longitudinal height of a single pixel, and the resolution ratio is a ratio of the horizontal number of pixels to the longitudinal number of pixels of the video; and
calculating a product value of the pixel ratio and the resolution ratio of the image of the video source, wherein the product value is the aspect ratio of the video source.

33. A computer-readable storage medium recording a program configured to execute the method for adjusting the aspect ratio according to any one of claims 18 to 32.

34. A device for adjusting aspect ratio of smart TV, characterized by comprising:
an identification module, configured to identify an aspect ratio of an inputted video source and a screen size of a display device;
a pre-adjustment module, coupled with the identification module and configured to adjust a image of the video source proportionally according to the aspect ratio of the video source such that a image width of the video source is equal to a screen width of the display device;
an acquisition module, coupled with the identification module and configured to acquire a image height of the video source after adjustment according to the aspect ratio of the video source and the screen width of the display device; and
an adjustment module, coupled with the identification module, the acquisition module and the pre-adjustment module respectively, and configured to longitudinally adjust the image of the video source after adjustment according to a screen height of the display device and the image height of the video source after adjustment.

35. The device for adjusting the aspect ratio according to claim 34, characterized in that,
the adjustment module is further configured to, when the image height is greater than the screen height, cut the portion of the adjusted image longitudinally exceeding an upper edge and a lower edge of a screen, display a retained portion in the image after cutting, and not display the cut portion in the image.

36. The device for adjusting the aspect ratio according to claim 34, characterized in that,
the adjustment module is further configured to, when the image height is greater than the screen height, longitudinally compress the adjusted image in a uniform proportion according to the screen height such that the compressed image height is equal to the screen height.

37. The device for adjusting the aspect ratio according to claim 34, characterized in that,
the adjustment module is further configured to, when the image height is greater than the screen height, longitudinally compress the portions of the adjusted image longitudinally exceeding an upper edge and a lower edge of the screen to an upper edge and a lower edge of the screen to display.

38. The device for adjusting the aspect ratio according to claim 37, characterized in that,
the adjustment module is further configured to respectively configure an upper compression boundary and a lower compression boundary in the upper edge and the lower edge of the screen according to a ratio of the portions of the adjusted image longitudinally exceeding the upper edge and the lower edge of the screen in the image height of the video source after adjustment; and correspondingly compress the portions of the adjusted image respectively exceeding the upper compression boundary and the lower compression boundary within a zone from the upper compression boundary and the lower compression boundary to the upper edge and the lower edge of the screen to display.

39. The device for adjusting the aspect ratio according to claim 38, characterized in that,
a image compression ratio from the upper compression boundary and the lower compression boundary to the upper edge and the lower edge of the screen is correspondingly increased during the compression of the adjustment module, so as to ensure a smooth transition of the image of the video source along a direction from the center of the screen to the edge of the screen in the upper compression boundary and the lower compression boundary.

40. The device for adjusting the aspect ratio according to claim 38 or 39, characterized in that,
for the portion of the image between the upper compression boundary and the lower compression boundary after the compression of the adjustment module, the image is not deformed; and after the compression of the adjustment module, the closer the portion of the image outside the upper compression boundary and the lower compression boundary is to the edge of the screen, the higher the deformation degree of the image is.

41. The device for adjusting the aspect ratio according to claim 38, characterized in that,
the higher the ratio is, the more partial the upper compression boundary and lower compression boundary is to the center of the screen, without exceeding a preset limit position.

42. The device for adjusting the aspect ratio according to claim 34, characterized in that,
the adjustment module is further configured to, when the image height is less than the screen height, fill a black edge respectively in the portion of the adjusted image from the upper edge and lower edge of the image to the upper edge and lower edge of the screen.

43. The device for adjusting the aspect ratio according to claim 34, characterized in that,
the adjustment module is further configured to, when the image height is less than the screen height, longitudinally stretch the adjusted image in a uniform proportion according to the screen height such that the stretched image height is equal to the screen height.

44. The device for adjusting the aspect ratio according to claim 34, characterized in that,
the adjustment module is further configured to, when the image height is less than the screen height, longitudinally stretch the portion of the adjusted image in the upper edge and lower edge to overspread the screen of the display device.

45. The device for adjusting the aspect ratio according to claim 44, characterized in that,
the adjustment module is further configured to respectively configure an upper stretching boundary and a lower stretching boundary in the upper edge and the lower edge of the image according to a ratio of the portion from the upper edge and the lower edge of the image to the upper edge and the lower edge of the screen in the image height of the video source; and correspondingly stretch the portion of the image from the upper stretching boundary and the lower stretching boundary to the upper edge and the lower edge of the image to the upper edge and the lower edge of the screen from the upper stretching boundary and the lower stretching boundary.

46. The device for adjusting the aspect ratio according to claim 45, characterized in that,
a image stretching ratio from the upper stretching boundary and the lower stretching boundary to the upper edge and the lower edge of the screen is correspondingly increased during the stretching of the adjustment module, so as to ensure a smooth transition of the image of the video source along a direction from the center of the screen to the edge of the screen in the upper stretching boundary and the lower stretching boundary.

47. The device for adjusting the aspect ratio according to claim 45 or 46, characterized in that,
for the portion of the image between the upper stretching boundary and the lower stretching boundary after stretching the adjustment module, the image is not deformed; and after stretching the adjustment module, the closer the portion of the image outside the upper stretching boundary and the lower stretching boundary is to the edge of the screen, the higher the deformation degree of the image is.

48. The device for adjusting the aspect ratio according to claim 45, characterized in that,
the higher the ratio is, the more partial the upper stretching boundary and lower stretching boundary is to the center of the screen, without exceeding a preset limit position.

49. The device for adjusting the aspect ratio according to claim 34, characterized in that,
the identification module is further configured to acquire a pixel ratio and a resolution ratio of the image of the video source; wherein the pixel ratio is a ratio of a transverse width to a longitudinal height of a single pixel, and the resolution ratio is a ratio of the horizontal number of pixels to the longitudinal number of pixels of the video; and calculate a product value of the pixel ratio and resolution ratio of the image of the video source, wherein the product value is the aspect ratio of the video source.

50. A device for adjusting aspect ratio of smart TV, characterized by comprising:
an identification module, configured to identify an aspect ratio of an inputted video source and a screen size of a display device;
a pre-adjustment module, coupled with the identification module and configured to adjust a image of the video source proportionally according to the aspect ratio of the video source such that a image height of the video source is equal to a screen height of the display device;
an acquisition module, coupled with the identification module and configured to acquire a image width of the video source after adjustment according to the aspect ratio of the video source and the screen height of the display device; and
an adjustment module, coupled with the identification module, the acquisition module and the pre-adjustment module respectively, and configured to transversely adjust the image of the video source after adjustment according to a screen width of the display device and the image width of the video source after adjustment.

51. The device for adjusting the aspect ratio according to claim 50, characterized in that,
the adjustment module is further configured to, when the image width is greater than the screen width, cut portions of the adjusted image transversely exceeding a left edge and a right edge of a screen, display a retained portion in the image after cutting, and not display the cut portions in the image.

52. The device for adjusting the aspect ratio according to claim 50, characterized in that,
the adjustment module is further configured to, when the image width is greater than the screen width, transversely compress the adjusted image in the uniform proportion according to the screen width such that the compressed image width is equal to the screen width.

53. The device for adjusting the aspect ratio according to claim 50, characterized in that,
the adjustment module is further configured to, when the image width is greater than the screen width, transversely compress the portions of the adjusted image transversely exceeding a left edge and a right edge of the screen to the left edge and the right edge of the screen to display.

54. The device for adjusting the aspect ratio according to claim 53, characterized in that,
the adjustment module is further configured to respectively configure a left compression boundary and a right compression boundary in the left edge and the right edge of the screen according to a ratio of the portions of the adjusted image transversely exceeding the left edge and the right edge of the screen in the image width of the video source after adjustment; and correspondingly compress the portions of the adjusted image respectively exceeding the left compression boundary and the right compression boundary within a zone from the left compression boundary and the right compression boundary to the left edge and the right edge of the screen to display.

55. The device for adjusting the aspect ratio according to claim 54, characterized in that,
a image compression ratio from the left compression boundary and the right compression boundary to the left edge and the right edge of the screen is correspondingly increased during the compression of the adjustment module, so as to ensure a smooth transition of the image of the video source along a direction from the center of the screen to the edge of the screen in the left compression boundary and the right compression boundary.

56. The device for adjusting the aspect ratio according to claim 53 or 54, characterized in that,
after the compression of the adjustment module, for the portion of the image between the left compression boundary and the right compression boundary, the image is not deformed; and after the compression of the adjustment module, the closer the portion of the image outside the left compression boundary and the right compression boundary is to the edge of the screen, the higher the deformation degree of the image is.

57. The device for adjusting the aspect ratio according to claim 54, characterized in that,
the higher the ratio is, the more partial the left compression boundary and right compression boundary is to the center of the screen, without exceeding a preset limit position.

58. The device for adjusting the aspect ratio according to claim 50, characterized in that,
the adjustment module is further configured to, when the image width is less than the screen width, transversely stretch the adjusted image in the uniform proportion according to the screen width such that the stretched image width is equal to the screen width.

59. The device for adjusting the aspect ratio according to claim 50, characterized in that,
the adjustment module is further configured to, when the image width is less than the screen width, transversely stretch the portions of the adjusted image in the left edge and the right edge to overspread the screen of the display device.

60. The device for adjusting the aspect ratio according to claim 59, characterized in that,
the adjustment module is further configured to respectively configure a left stretch boundary and a right stretch boundary in the left edge and the right edge of the image according to a ratio of the portion from the left edge and the right edge of the image to the left edge and the right edge of the screen in the image width of the video source; and correspondingly stretch the portion of the image from the left stretch boundary and the right stretch boundary to the left edge and the right edge of the image to the left edge and the right edge of the screen from the left stretch boundary and the right stretch boundary.

61. The device for adjusting the aspect ratio according to claim 60, characterized in that,
the image stretching ratio from the left stretch boundary and the right stretch boundary to the left edge and the right edge of the screen is correspondingly increased during the stretching of the adjustment module, so as to ensure a smooth transition of the image of the video source along a direction from the center of the screen to the edge of the screen in the left stretch boundary and the right stretch boundary.

62. The device for adjusting the aspect ratio according to claim 60 or 61, characterized in that,
after stretching of the adjustment module, for the portion of the image between the left stretch boundary and the right stretch boundary, the image is not deformed; and after stretching of the adjustment module, the closer the portion of the image outside the left stretch boundary and right stretch boundary is to the edge of the screen, the higher the deformation degree of the image is.

63. The device for adjusting the aspect ratio according to claim 60, characterized in that,
the higher the ratio is, the more partial the left stretch boundary and right stretch boundary is to the center of the screen, without exceeding a preset limit position.

64. The device for adjusting the aspect ratio according to claim 50, characterized in that,
the identification module is further configured to acquire a pixel ratio and a resolution ratio of the image of the video source; wherein the pixel ratio is a ratio of a transverse width to a longitudinal height of a single pixel, and the resolution ratio is a ratio of the horizontal number of pixels to the longitudinal number of pixels of the video; and calculate a product value of the pixel ratio and resolution ratio of the image of the video source, wherein the product value is the aspect ratio of the video source.
